(19) United States
(12) Patent Application Publication
(10) Pub. No.: US 2010/0288478 A1
(43) Pub. Date: Nov. 18, 2010

(54) Remanufactured Exhaust Gas Recirculation Cooler and Method for Remanufacturing a Cooler

(76) Inventors: Lawrence Barron, Jamestown, NY (US); Matthew Moore, Jamestown, NY (US); Paul Smith, Sinclairville, NY (US)

Correspondence Address: THE BILICKI LAW FIRM, PC, 1285 North Main Street, JAMESTOWN, NY, 14701, US

(21) Appl. No.: 12/464,836

(22) Filed: May 12, 2009

(51) Int. Cl. F28F 1/00; B23P 6/00

(52) U.S. Cl. 165/173; 29/890.054

(57) ABSTRACT

A method of remanufacturing coolers, such as exhaust gas recirculation coolers, is provided. The method includes providing an exhaust gas recirculation cooler having cooling tubes attached to a header plate and an outer shell. At least one opening is milled in the outer shell to expose a portion of the cooling tubes. Brazing material is then injected into the cooler through the opening such that the brazing material, when heated, forms a fillet around each cooling tube adjacent to the header plate. A cover positioned over the opening and the cooler is heated to a brazing temperature, such that the brazing material flows around the cooling tubes, thereby reinforcing the tubes and repairing cracks in the tubes. Clips having a C-shaped configuration may also be positioned within the cooling tubes to further strengthen and repair the cooling tubes.

### BRIEF DESCRIPTION OF THE DRAWINGS

In the accompanying drawings:

FIG. 1 illustrates a perspective view of an engine gas recirculation cooler having a window formed therein.

FIG. 2 is a side view of the header end of the engine gas recirculation cooler of FIG. 1.

FIG. 3 is an enlarged front view of the header end of the engine gas recirculation cooler of FIG. 1 with a front window.

FIG. 4 is an enlarged side view of the header end of the engine gas recirculation cooler of FIG. 1 with a side window.

FIG. 5 is an enlarged back view of a header end of the engine gas recirculation cooler of FIG. 1 with a back window.

FIG. 6 illustrates a section of an engine gas recirculation cooler with a crack formed therein.

FIG. 7 illustrates a flow diagram for the method of treatment of an engine gas recirculation cooler.

FIG. 8 illustrates a section of an engine gas recirculation cooler with a spot welded window cover.

FIGS. 9 and 9A illustrate enlarged views of the cooling tubes with a braze fillet.

FIG. 10 illustrates a perspective view of a cooling tube bundle of the engine gas recirculation of FIG. 1.

FIG. 11 illustrates a perspective view of a cooling tube bundle having clips inserted therein.

FIGS. 12-15 illustrate alternate views of the clips of FIG. 11.

### DETAILED DESCRIPTION

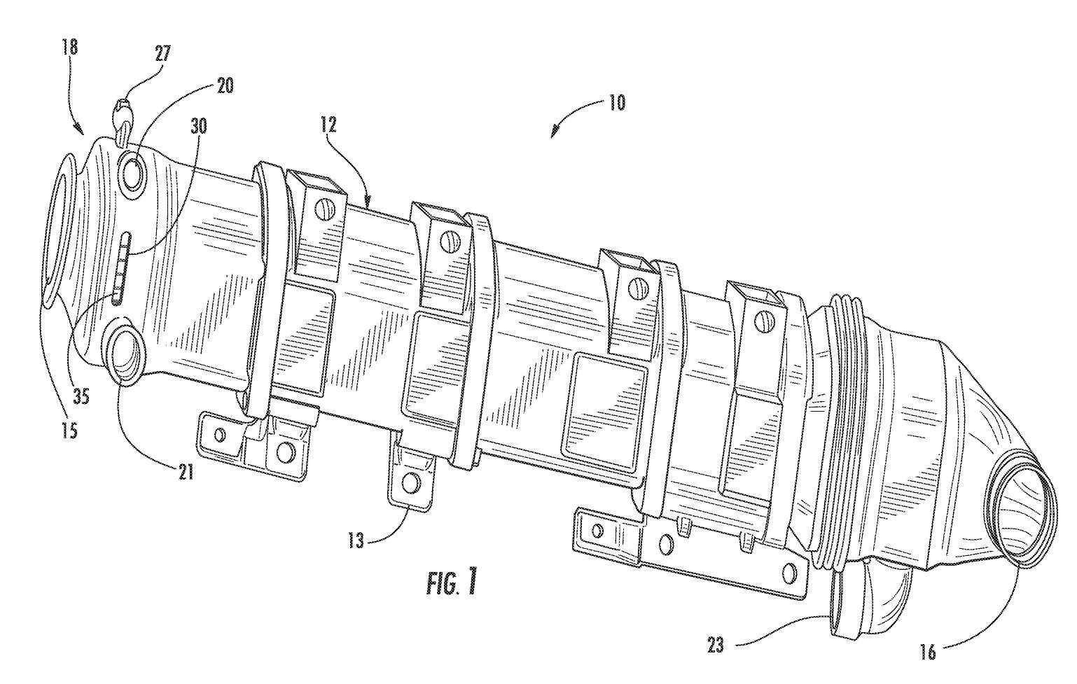

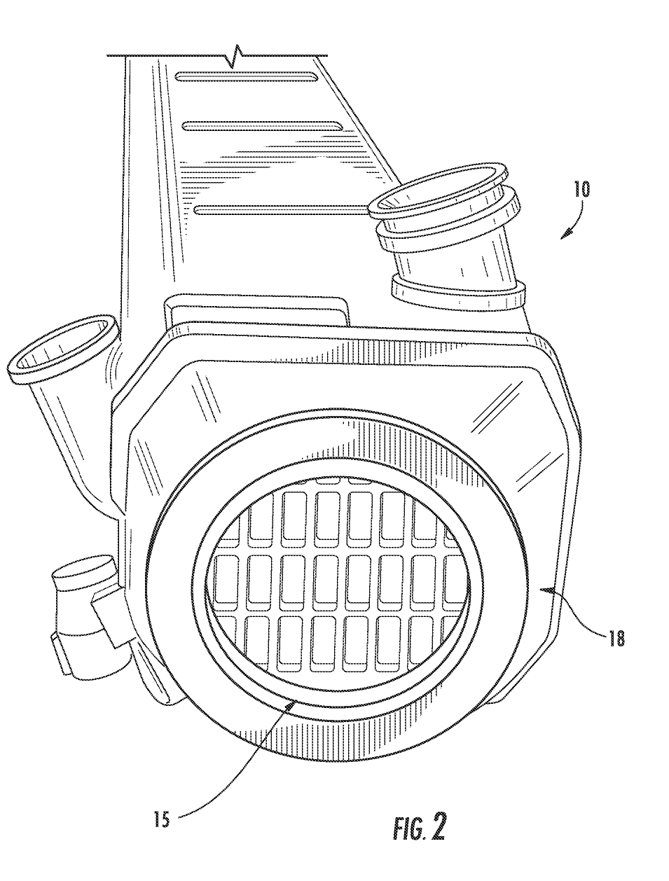

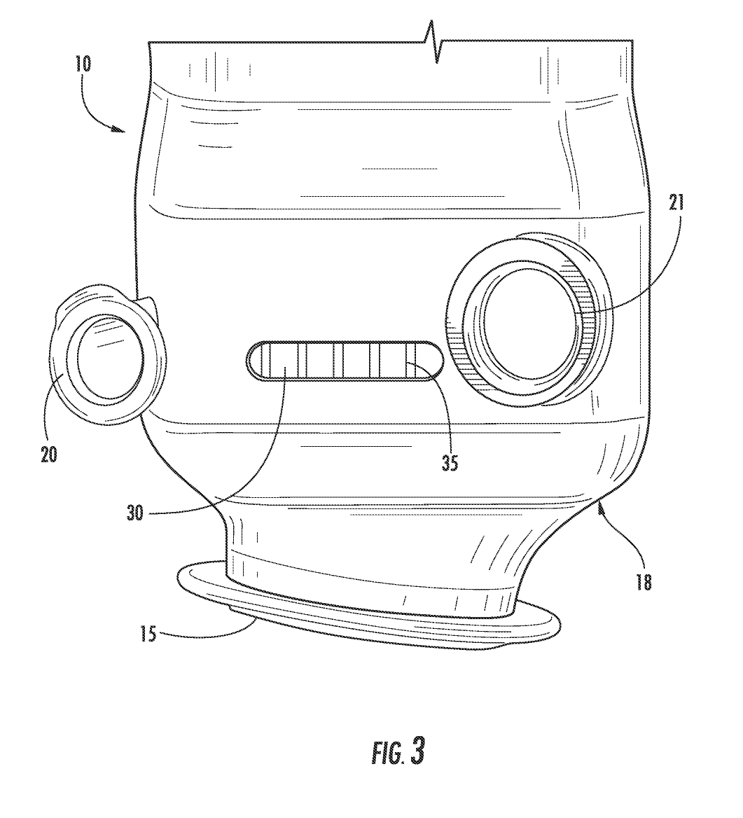

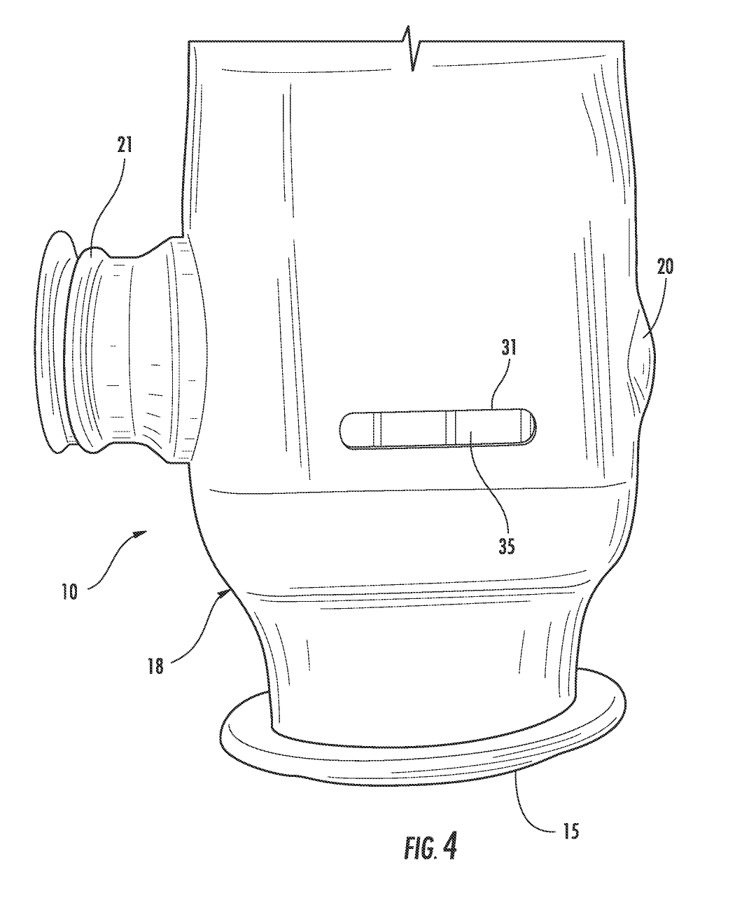

Referring to FIG. 1, an exhaust gas recirculation (EGR) cooler 10, having an outer shell 12, made of stainless steel, for cooling the exhaust gas is illustrated. The EGR cooler 10 has a first coolant inlet 20 and a second coolant inlet 21. Tubes 35 are disposed in the form of a tube bundle within the outer shell 12 of the EGR cooler 10. Coolant is passed into EGR cooler 10 through the first coolant inlet 20 and the second coolant inlet 21. A coolant outlet 23 is provided at an opposite end of the EGR cooler 10 for the removal of the coolant from the EGR cooler 10. Hot gasses enter into the EGR cooler 10 through an exhaust gas inlet 15 formed on a header end 18 of the EGR cooler 10, as shown in FIG. 2. The gasses are cooled by the coolant as the gasses pass through the tubes. After the gas passes through the cooler, the cooled exhaust gas is ejected through an exhaust gas outlet 16. An air vent 27 is provided on a header end 18 of EGR cooler 10 to allow air to escape. For mounting purposes, a mounting bracket 13 is provided over the outer shell 12. A plurality of such mounting brackets may be provided, as needed. As shown in FIGS. 3-5, one or more windows, 30-32, are cut within outer shell 12, as will be described in more detail below.

In a typical construction of an EGR cooler 10, which is essentially a tube bundle heat exchanger, cooling tubes 35 of a circular or rectangular cross-section are held in place at their ends with a header plate 40 at header end 18 of EGR cooler 10. In addition to retaining the tubes, the header plate 40 prevents flow communication between the cooling tube interiors and the interior of outer shell 12. The cooling tubes 35 and the header plate 40 are typically joined by welded or brazed butt joints between outer side surfaces of the tubes and peripheral edges of perforations in the header plate 40. Similarly, the header plate 40 is typically sealed to the inner surface of the outer shell 12 by a welded or brazed butt joint. However, such joints result in relatively small sealing surfaces and are susceptible to stress-induced failure. High stresses caused by thermal cycling effects are of particular concern in high temperature heat exchangers, such as EGR coolers.

EGR cooler 10 may also include one or more baffle plates (not shown) which maintain proper spacing between the tubes 35 and to guide the flow of the coolant within outer shell 12. The baffle plates may, for example, be annular plates that are brazed in place. Although the EGR cooler 10 may include baffle plates, it will be appreciated that baffle plates are not an essential component of EGR cooler 10.

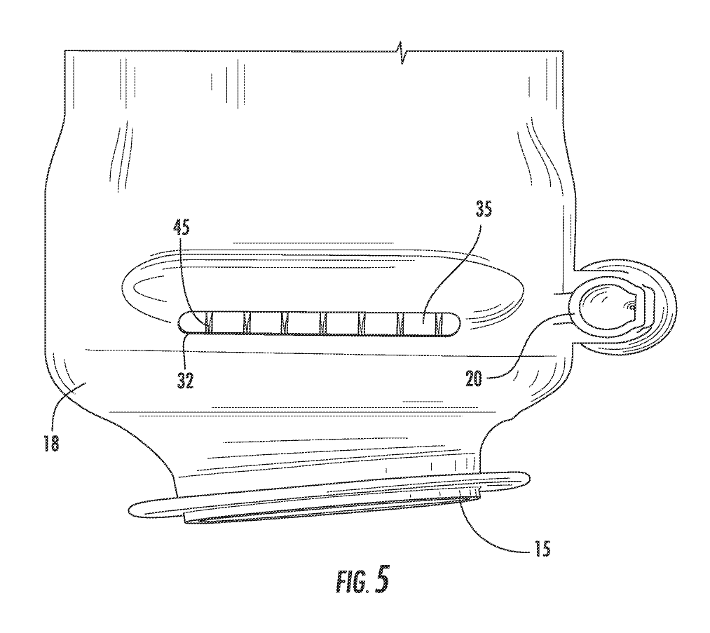

In general, EGR coolers 10, as shown in FIG. 1, are used to cool down diesel engine exhaust, from approximately 600-700 degrees Celsius to 100-200 degrees Celsius, so that the exhaust gas can be fed back or re-injected into the engine. However, due to a constant flow of corrosive fluids such as high-temperature exhaust gas, sulphuric and nitric acid, cooling water and exhaust gas condensate, the EGR coolers 10 often develop cracks in the tubes 35. Thus, coolant leaks into the tubes 35 and from the outer shell 12 of the EGR cooler 10. For example, as shown in FIG. 6, corrosive fluids flowing through the EGR cooler 10 may penetrate into cracks 34 in the outer shell 12 causing crevice corrosion. This causes a higher failure rate for the engines. It is desirable to remanufacture such field-failed and returned exhaust gas recirculation coolers (EGR), so as to seal the cracks in the cooling tubes and prolong the life of the EGR cooler. For this, brazing is carried out with a high strength corrosion resistant brazing alloy. Brazing generally includes joining a base metal surface by fusing a filler metal, having a lower liquidus temperature than the subject base material, without appreciable fusion of the base materials themselves.

In order to repair or prevent cracks in EGR coolers 10, such as the cracks shown in FIG. 6, brazing material is injected into the outer shell 12 and around the cooling tubes 35 through at least one opening or window. The EGR cooler 10 is shown having a front window 30 formed therein, between the first coolant inlet 20 and the second coolant inlet 21, for exposing a portion of the cooling tubes 35. Similarly, side windows 31 and back window 32 may be cut within outer shell 12 to expose additional areas of cooling tubes 35 such that brazing material may be injected into EGR cooler 10. As the EGR cooler 10 is made from stainless steel, the brazing material must be compatible, both chemically and metallurgically, with the base metal parts being brazed. The brazing material should be corrosion resistant and must be able to withstand high temperature ranges. For example, one compatible brazing material is Nicorbraz (NB) 130, which commercially available from Wall Colmonoy (WC). WC's Nicorbraz (NB) 130 contains 3.1 percent boron, 3.5 percent silicon and 0.03 percent to 0.06 percent carbon, with the balance being nickel. NB 130 is a general purpose filler metal which flows freely in marginal atmosphere and in deep or tight joints. Other NB brazing fillers, such as NB LM, may also be used. NB LM contains by composition: 7% Cr, 3% Fe, 2.9% B, 4.5% Si, maximum of 0.1% C, and the balance Ni. Alternatively, other suitable brazing filler materials, that are compatible with the stainless steel shell and exhibit high strength and corrosion resistance, may be used.

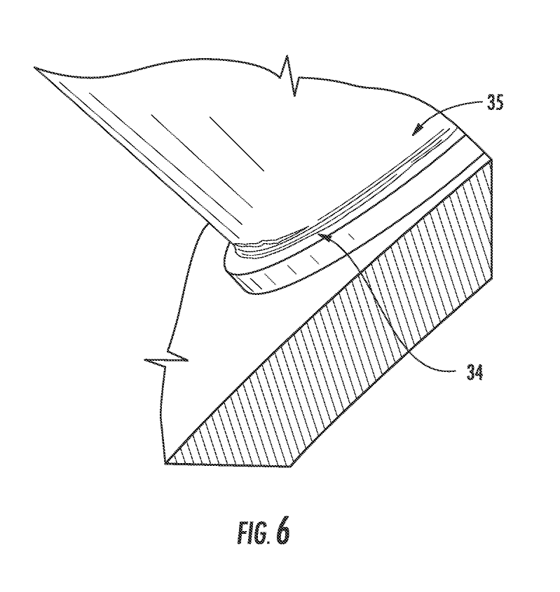

FIG. 7 illustrates a flow diagram for a method of remanufacturing a field-failed EGR cooler 10 having cracks in its gas cooling tubes 35 or outer shell 12, such as those shown in FIG. 6. As illustrated, the process involves a milling or forming cycle 41, a cleaning cycle 42 and a brazing cycle 43. In the milling or forming cycle, at least one window 30 (as seen in FIG. 1) is milled or otherwise formed within EGR cooler 10, for application of the brazing material. Window may be formed in cooler 10 by any one of various known methods for creating an opening in a metal structure, such as by milling, cutting, or laser forming. As discussed above, front window 30 is formed at the exhaust gas inlet 15 formed on the header end 18 of the EGR cooler 10. However, care must be taken to evacuate any metal chips produced during the milling or forming process; otherwise, chips deposited on the cooling tubes 35 and remaining thereon in the subsequent brazing cycle could damage the gas cooling tubes 35. Accordingly, the passageways for the EGR cooler 10 are plugged and cooler is pressurized and the chips, if any, are evacuated. In one embodiment, the forming step constitutes front window 30 being laser cut into EGR cooler 10 by a 5-axis laser. Additional windows, such as side and back windows, 31 and 32, may be formed so as to facilitate multiple injection ports for the brazing material. This maximizes application of the brazing material around the perimeter of the cooling tube bundle and the perimeter of each gas cooling tube 35 at the base of each tube where the cooling tubes are joined to header plate 40.

Following the milling or forming cycle, the EGR cooler 10 is processed through the cleaning cycle 42. Generally, field-failed EGR coolers 10 to be manufactured have surfaces that are caked with, among other things, dust, dirt, grease, and carbon. In order for the brazing cycle to be effective, the coolers must be sufficiently clean before the brazing material can be applied. Thus, the EGR cooler 10 is subjected to, for example, a triple ultrasonic cleaning bath, wherein, it is cleaned using a suitable cleaning solution, prior to the brazing cycle. The cleaning cycle may be carried out on or off-site. For example, equipment for ultrasonic cleaning of EGR coolers is commercially available from Blackstone-Ney Ultrasonics and Chautauqua Metal Finishing Supply. In one embodiment, the EGR cooler 10 is be cleaned in an ultrasonic cleaner with agitation, such as a Miraclean Parts Washer. Ultrasonic cleaning takes place when high frequency bursts of ultrasonic energy are applied to a heated liquid cleaning solution that surrounds the parts. This energy produces a three-dimensional wave pattern of alternating positive and negative pressure areas within a cleaning tank. The alternating pattern creates bubbles during periods of negative pressure and implodes them during periods of positive pressure in a phenomenon known as “cavitation.” Lower frequencies (20-40 kHz) are safe for most applications and will produce the most intense cavitation energies to remove the most common types of contaminants (oil, grease, metal chips). The EGR cleaning takes place at 25 kHz in an ultrasonic cleaner with agitation at a temperature of approximately 71 degrees Celsius for 60 minutes. Appropriate cleaning solutions include QC liquid mold cleaner and RD 531 at 10% by volume each; both are commercially available from Miraclean. The QC liquid mold cleaner is a heavy-duty high alkaline liquid degreaser for use in soak and ultrasonic applications. The RD 531 cleaner is a silicate-free, heavy-duty detergent for use in soak and ultrasonic cleaning systems. It is safe on ferrous and non-ferrous metals. RD 531 is suitable for removal of buffing and lapping compounds. It may also be used for removal of general machine oils. Following the ultrasonic cleaning, the cooler 10 is rinsed with tap water and allowed to air dry. A boroscope may be used to determine whether the EGR cooler 10 has been sufficiently cleaned, prior to the initiation of the brazing cycle.

After the cleaning cycle, the EGR cooler 10 is processed through the brazing cycle 43. During the brazing cycle, the brazing material is initially injected into the EGR cooler 10, as indicated at step 45. A portioned amount of brazing material is injected through each of the windows, the front window 30, the side window 31 and the back window 32, into the header end 18 and on header plate 40. This maximizes the opportunity for the hot brazing material to surround the base of each of the cooling tubes once the brazing material liquefies during the brazing cycle. Sufficient brazing material is injected through the windows, 30, 31, and 32, so that the brazing material, when heated, travels by way of capillary action, up the cooling tubes 35 at least 0.25 millimeters and up to 3.0 millimeters, thereby reinforcing cooling tubes 35. However, the amount of back fill brazing material injected must be carefully controlled to avoid flowing into areas where it is neither needed nor wanted, as well as to avoid inter-alloying of base metal and brazing filler material which could be harmful to the joint strength.

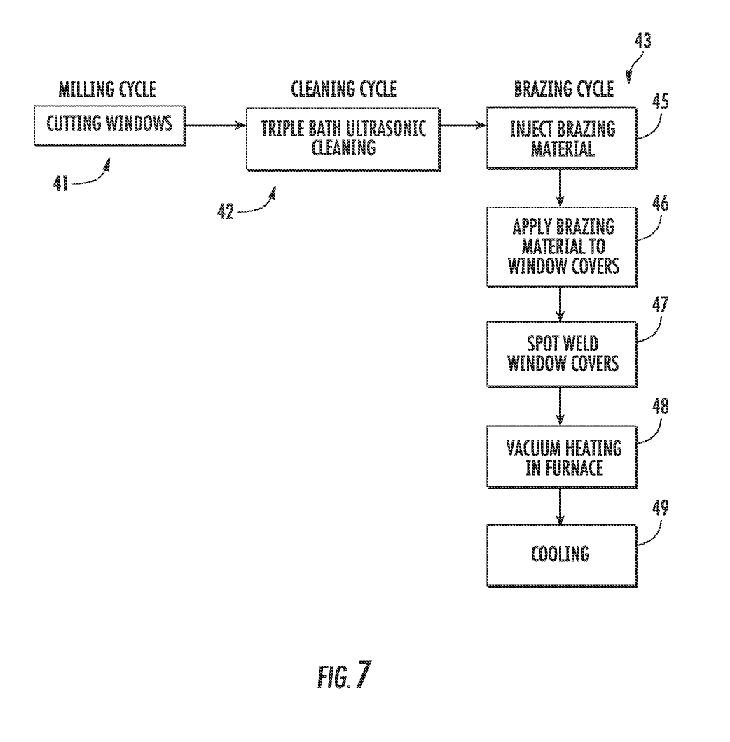

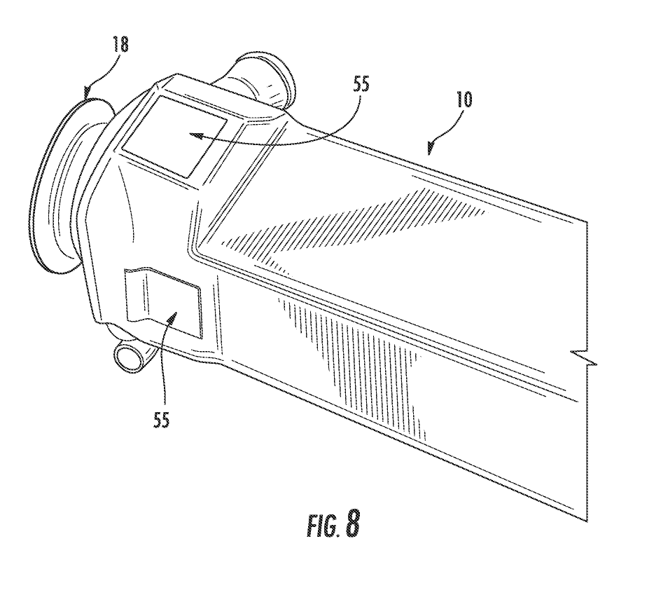

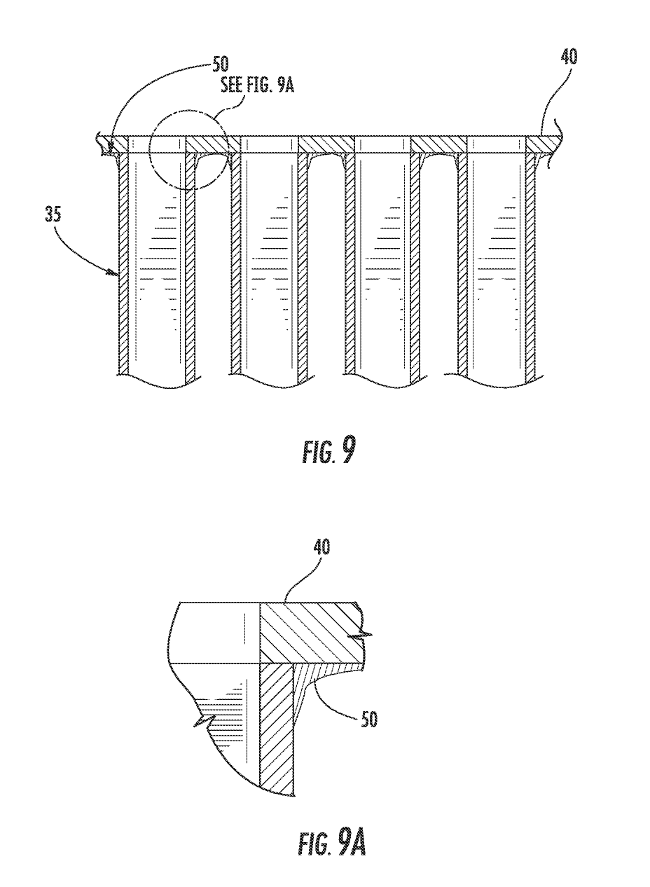

After the brazing material is injected though each of windows 30, 31, and 32, the EGR cooler is subjected to positioning, application of brazing material and spot welding of the window covers, as indicated in steps 46-47. In these steps, each of the window covers, one of which is indicated at 55, are positioned over the openings from which they were removed. The window cover 55 may be self-locating in order to facilitate positioning over the openings or windows. In step 46, brazing material is then applied over the window cover 55. The window cover 55 is then spot welded into its respective place, as shown in step 47 of FIG. 7. In an alternate embodiment, cover 55 may be secured to cooler 10 by a fastening assembly including a fastener, such as a screw or bolt (not shown) and a gasket surrounding window 10. The fastening assembly is secured by a tapping or drilling process. Once the window covers 55 are in place over each of the windows 30, 31, and 32, and spot welded in place, the EGR cooler 10 is subjected to a vacuum brazing procedure (step 48) wherein one or more EGR coolers 10 are placed in a braze rack, in a vertical position, such that the exhaust gas inlet end 15 of each EGR cooler 10 is facing downwards. The loaded braze racks are then placed in a vacuum furnace for brazing. Vacuum brazing is carried out, wherein, the brazing filler material is heated in vacuum up to 1066 degrees Celsius, in such an atmosphere that the vacuum degree is set to be about 1×10⁻² Pa or less. Both hot wall retort and cold wall radiant shield furnaces may be used for the vacuum brazing. Such heating of the brazing alloy during the brazing cycle turns the brazing filler material into a liquid. The brazing liquid travels by capillary action up each of the cooling tubes 35 approximately 0.25-3 mm, typically 0.5 to 1.0 mm, from the header plate 40, forming a braze fillet 50, as illustrated in FIGS. 9 and 9a.

FIG. 10 is a perspective view of the coolant bundle 38 of FIG. 9. FIG. 10 illustrates the header end 18 depicting a narrow or short side (not separately labeled) of each of the cooling tubes 35. The braze fillet 50, formed by such a capillary action, produces a leak tight joint at the header end 18. As is understood in the art, the brazing filler material may be used in the form of powder, paste, foil or sheet when it is applied to the brazing part. Vacuum brazing, as described above, may be used for the brazing of multi-tubular EGR coolers 10, plate-type EGR coolers, honey-comb EGR coolers and the like. The brazing process may also be carried out using a torch heating, induction heating or any other similar heating in a controlled atmosphere furnace. Once the brazing cycle is completed the braze racks are removed from the furnace and the brazed EGR coolers 10 are removed from the racks. In step 49, each EGR cooler 10 is then cooled to solidify the braze material. Following the cooling of the EGR cooler 10 any cracks in the cooling tubes 35 are sealed with the solidified brazing material. Thus, the remanufactured EGR cooler 10 exhibits a prolonged life and is more efficient in the cooling of exhaust gas.

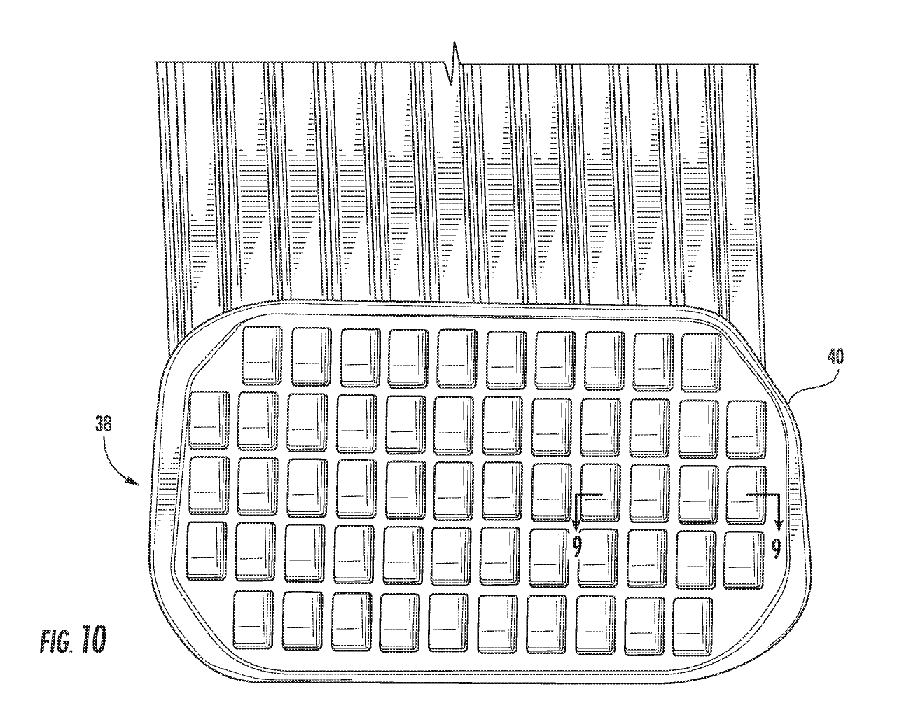

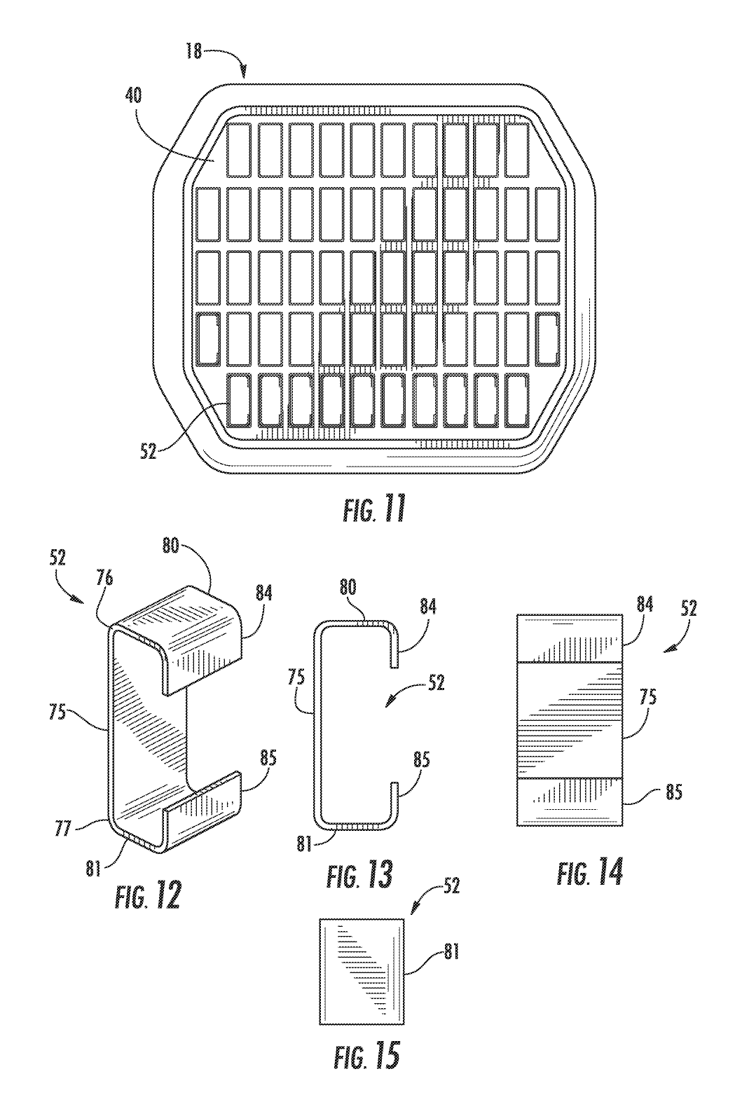

In accordance with a second embodiment, as depicted in FIGS. 11-15, the cooling tubes 35 of the EGR cooler 10 are further reinforced with clips 52 that are inserted into the cooling tubes 35. In this embodiment, the clips 52 are used in conjunction with the brazing process of the first embodiment described above. Clips 52 are formed of stainless steel or any other material of sufficient strength and heat resistance. Clips 52 are generally C-shaped, with a long edge 75 having first and second ends 76 and 77. Two radially extending edges, 80 and 81, project from first and second ends 76 and 77 of long edge 75. In addition, each clip 52 includes two short edges, 84 and 85, extending perpendicularly to radially extending edges, 80 and 81, and parallel to long edge 75. Each edge 75, 80, 81, 84, and 85 is in contact with a respective side wall of a cooling tube. Thus, the C-shaped configuration of clips 52 causes very little restriction in gas flow traveling through cooling tubes 35. In addition the C-shape allows clips 52 to be easily inserted into cooling tubes 35 and provides some flexibility to accommodate slight variations in the size and shape of cooling tubes 35. More specifically, the space (not separately labeled) between short edges 84 and 85 allows for slight movement of edges 80 and 81 such that clips 52 may be slightly manipulated to fit within tubes 52.

In the embodiment shown in FIG. 11, clips 52 are inserted into all of the cooling tubes 35 on the lower end of the cooling tube bundle 38. Clips 52 provide strength at areas of stress in cooling tubes 35, while retaining some heat transfer properties. As illustrated in FIG. 11, clips 52 are also inserted in cooling tubes on either side of the bundle 38 closest to the header plate 40, thereby forming a horseshoe pattern as illustrated in FIG. 11. Clips 52 need not be inserted into every cooling tube 35 of the cooling tube bundle 38. However, the clips 52 may be inserted into tubes 35 at the outside region of the bundle since the outermost tubes are most subject to thermal stress. In this embodiment, the horseshoe pattern is used because the cooling tubes 35 in this configuration often form cracks. The clips may be placed in any of the cooling tubes 35 exhibiting cracks or in tubes most likely to form cracks. Clips 52 are installed in the EGR cooler 10 by removing the exhaust gas inlet 15, such as by cutting. When inserted into cooling tubes 35, clips 52 approximately double the thickness of the failed cooling tubes 35, thereby reinforcing the strength of the tubes 35 at the header end of the EGR cooler 10. As the insert clips 52 are used along with the brazing material in this embodiment, the clips 52 help in preventing the brazing material from migrating too far down the cooling tubes 35.

Brazing material is applied to the interior walls of cooling tubes 35, to the clips 52, or both. The clips are then inserted into tubes 35 to form a structure resistant to the required operating temperatures and pressures of the cooler, while also retaining heat transfer properties. Following the insertion of the clips 52 within cooling tubes 35, brazing material is applied to the exterior of the cooling tubes 35 at the header plate 40, as described above with reference to the first embodiment. In summary, windows are milled in outer shell 12 and brazing material is injected into the cooler along the base of the tube bundle 38 at the header plate 40. The window covers are then returned to the windows and the cooler is brazed in an oven. Thus, the clips are brazed in place on the interior of cooling tubes 35 and fillets form around an exterior of the cooling tubes 35 adjacent to the header plate 40.

In accordance with a third embodiment, the treatment of an EGR cooler 10 involves inserting only the clips into the cooling tubes 35, without applying the brazing material to the outer surface of the cooling tubes 35 to for a fillet around the base of each tube, as in the first and second embodiments. According to the third embodiment, the clips are positioned within the cooling tubes 35 in a similar manner to the embodiment described above. The clips are brazed in place within an interior of selected cooling tubes 35. As explained above, the clips may be C-shaped to allow the clips to be inserted into cooling tubes 35 having slight variations in size. The clips are positioned within tubes 35 that are subject to the most thermal stress, such as in a horseshoe pattern around the perimeter of the tube bundle 38. Clips reinforce cooling tubes 35 by approximately doubling the thickness of the tubes. The clips may also be used in a newly manufactured EGR cooler to reinforce the cooling tubes 35 to protect against the occurrence of cracks.

While specific embodiments have been described in detail in the foregoing detailed description and illustrated in the accompanying drawings, those with ordinary skill in the art will appreciate that various modifications and alternatives to those details could be developed in light of the overall teachings of the disclosure. For example, this method of treating the field-failed exhaust gas recirculation (EGR) cooler may also be applied during the fabrication of a new EGR cooler in order to prevent cracking and prolong the life of the cooler. The brazing filler material and the brazing method provided may be used to braze any member of a heat exchanger such as a reformer cooler of a fuel cell, an oil cooler, a radiator, a secondary battery member, and the like. The clips 52 may be inserted in any of the cooling tubes, in any of the rows, so as to form any pattern other than the horseshoe pattern, as may be required. The examples used in the described embodiments, in no way limit the applicability.

We claim:

1-36. (canceled)

37. A method of treating a cooler, the method comprising the steps of:
a. providing the cooler having an outer shell, a header plate and a plurality of cooling tubes, each cooling tube having a header end for attachment to said header plate;
b. forming at least one opening in said outer shell for providing access to said plurality of cooling tubes;
c. cleaning the cooler;
d. injecting a brazing material in the opening, the brazing material being directed towards said header plate;
e. heating the cooler including the brazing material to a brazing temperature, such that the brazing material forms a fillet around at least one cooling tube of said plurality of cooling tubes where the cooling tube is attached to said header plate; and
f. cooling the cooler including the brazing material to solidify the brazing material.

38. The method of claim 37 further comprising a step of positioning a cover over said opening.

39. The method of claim 38 wherein said step of positioning a cover over said opening occurs prior to heating the cooler.

40. The method of claim 39 further comprising a step of spot welding said cover over said opening.

41. The method of claim 37, wherein the cooler is an exhaust gas recirculation cooler for a diesel engine.

42. The method according claim 37, wherein the outer shell of the cooler is stainless steel.

43. The method according claim 37, wherein the step of injecting a brazing material into the opening further includes the step of providing a brazing material comprising nickel.

44. The method according to claim 40, wherein the brazing material further includes boron, silicon and carbon.

45. The method according to claim 41, wherein the brazing material further includes chromium and iron.

46. The method according to claim 37, wherein the step of injecting the brazing material into the opening further includes the step of providing a sufficient amount of braze material such that the brazing material, when heated, flows around said at least one cooling tube of said plurality of cooling tubes by capillary action to form a fillet.

47. The method according to claim 43, wherein the fillet extends approximately 0.25-3.0 mm in length along said at least one cooling tube from the header plate along said cooling tube.

48. The method according to claim 37, wherein the step of cleaning the cooler includes subjecting the cooler to at least one ultrasonic cleaning cycle.

49. The method according to claim 37, wherein heating takes place in a vacuum furnace.

50. The method according to claim 37, wherein the step of providing the cooler having cooling tubes and an outer shell comprises providing a new exhaust gas recirculation cooler.

51. The method according to claim 37, wherein the step of providing the cooler having cooling tubes and an outer shell comprises providing a cooler having cooling tubes wherein at least one of the cooling tubes has a crack therein.

52. The method according to claim 51, wherein the step of providing the cooler having cooling tubes and an outer shell comprises providing a field failed cooler to be remanufactured.

53. The method according to claim 37 further comprising inserting at least one clip into at least one cooling tube for reinforcing said cooling tube.

54. The method according to claim 52 wherein said clip includes an outer surface that abuts an interior surface of at least one cooling tube.

55. A cooler remanufactured according to the method of claim 37.

56. A method of remanufacturing a cooler, the method comprising the steps of:
a. providing a cooler having a plurality of cooling tubes attached to a header plate and an outer shell surrounding said plurality of cooling tubes and said header plate, wherein an interior surface of each cooling tube is accessible through said header plate;
b. providing access to said header plate;
c. inserting a clip having a generally c-shaped configuration into at least one cooling tube of said plurality of cooling tubes, said clip having an outer surface for abutting said interior surface of said at least one cooling tube, wherein said clip is secured within said cooling tube by brazing.

57. The method according to claim 56, wherein said clip is formed of stainless steel.

58. The method according to claim 56 further comprising the steps of:
d. exposing a portion of said plurality of cooling tubes;
e. cleaning the cooler;
f. placing a brazing material in the opening, the brazing material having a solidus temperature less than that of the outer shell;
g. positioning a cover over said opening;
h. heating the cooler including the cover, the outer shell around a perimeter of the opening, and the brazing material to a brazing temperature, such that the brazing material flows around at least one cooling tube of the plurality of cooling tubes where the cooling tube is attached to the header plate; and
i. cooling the cooler including the melted brazing material, cover portion and outer shell to solidify the brazing material.

59. An exhaust gas recirculation cooler remanufactured according to the method of claim 58.

60. A remanufactured cooler comprising:
a. an outer shell, a header plate and a plurality of cooling tubes, each cooling tube having a header end being attached to said header plate;
b. at least one opening in said outer shell for providing access to said plurality of cooling tubes;
c. at least one braze fillet formed at a base portion of at least one cooling tube of said plurality of cooling tubes where said cooling tube is attached to said header plate;
d. a cover brazed in place over said opening.

61. The remanufactured cooler according to claim 60, wherein the cooler is an exhaust gas recirculation cooler for a diesel engine.

62. The remanufactured cooler according to claim 60, wherein the outer shell of the cooler is stainless steel.

63. The remanufactured cooler according to claim 60, wherein the fillet is formed from brazing material comprising nickel.

64. The remanufactured cooler according to claim 60, wherein the brazing material further includes boron, silicon and carbon.

65. The remanufactured cooler according to claim 63, wherein the brazing material further includes chromium and iron.

66. The remanufactured cooler according to claim 60, wherein the fillet extends approximately 0.25-3.0 mm in length along said at least one cooling tube from the header plate along said cooling tube.

67. The remanufactured cooler according to claim 60 further comprising at least one clip positioned in an interior of at least one cooling tube.

68. The remanufactured cooler according to claim 67 wherein said clip includes an outer surface that abuts an interior surface of at least one cooling tube.

69. A remanufactured cooler comprising:
a. a plurality of cooling tubes attached to a header plate and an outer shell surrounding said plurality of cooling tubes and said header plate;
b. a clip having a generally c-shaped configuration positioned within at least one cooling tube of said plurality of cooling tubes, said clip having an outer surface for abutting an interior surface of said at least one cooling tube, wherein said clip is secured within said cooling tube by brazing.

70. The remanufactured cooler according to claim 69, wherein the cooler is an exhaust gas recirculation cooler.

71. The remanufactured cooler according to claim 69, wherein said clip is formed of stainless steel.

72. The remanufactured cooler according to claim 69 further comprising:
c. at least one opening in said outer shell for providing access to said plurality of cooling tubes;
d. at least one braze fillet formed at a base portion of at least one cooling tube of said plurality of cooling tubes where said cooling tube is attached to said header plate; and
e. a cover brazed in place over said opening.
